(19) United States
(12) Patent Application Publication
(10) Pub. No.: US 2012/0034327 A1
(43) Pub. Date: Feb. 9, 2012

(54) APPARATUS FOR COMPRESSION MOULDING PREFORMS

(75) Inventors: Zeno Zuffa, Borgo Tossignano (BO) (IT); Fiorenzo Parrinello, Medicina (BO) (IT)

(73) Assignee: SACMI COOPERATIVA MECCANICI IMOLA SOCIETA' COOPERATIVA, Imola (BO) (IT)

(21) Appl. No.: 13/201,273

(22) PCT Filed: Feb. 10, 2010
(86) PCT No.: PCT/IB10/50600

§ 371 Date: Oct. 25, 2011

(30) Foreign Application Priority Data
Feb. 13, 2009 (IT) MO2009A000036

(51) Int. Cl. B29C 43/34

(52) U.S. Cl. 425/129.1

(57) ABSTRACT

An apparatus for compression-moulding preforms from a dose of plastics comprises a punch arrangement, a die arrangement provided with a cavity and at least two die elements which are mutually movable between a contact position and a detached position. The punch arrangement comprising a punch suitable for being inserted into the cavity and a pressing sleeve mounted slidably around the punch to maintain the at least two die elements in the contact position. The punch arrangement further comprises a jacket arrangement arranged for receiving the punch and the pressing sleeve and at least a first chamber, containing a first fluid at a first pressure and acting on the pressing sleeve, which is entirely bounded by the pressing sleeve and by the jacket arrangement so as to enable the punch to be dismantled from the punch arrangement, maintaining the first chamber pressurised.

The invention relates to an apparatus for forming objects, in particular by compression-moulding plastics. The apparatus according to the invention is particularly suitable for forming preforms for containers, such as bottles, made, for example, of polyethyleneterephthalate (PET), polypropylene (PP), polyvinyl chloride (PVC), high-density polyethylene (HDPE) or polyethylene naphthalate (PEN). The preforms obtained by using the apparatus according to the invention can be subsequently transformed into containers, for example bottles, by a stretch-blow-moulding process.

The preforms for obtaining containers comprise a substantially cylindrical hollow body extending along a longitudinal axis having an end closed by a transverse wall that is generally dome-shaped. The hollow body further has an open end on which a mouth is obtained comprising a threaded zone that is suitable for engaging with a container closure. The open end of the preform is bounded by an edge zone that extends circumferentially around the longitudinal axis.

In manufacturing plants for producing the preforms, in order to offer the end customer containers that always have a different shape and less mass, manufacturing production batches of preforms in succession is becoming ever more frequent, each having a respective determined size. In other words, there is always greater need to offer an apparatus for the compression-moulding of preforms that is able to adapt to frequent requests for products that are different from one another (flexibility of demand). Manufacturing plants are known for forming preforms by compression-moulding of doses of plastics. Such plants comprise a plurality of moulds mounted in a peripheral region of a carousel that is rotatable around a vertical axis.

Each mould comprises a first half mould, a second half mould and two movable die elements. The first half mould comprises a punch, configured for shaping the substantially cylindrical internal surface of the hollow body of the preform; the second half mould comprises a die cavity, configured for shaping a substantially cylindrical portion of the external surface of the hollow body of the preform; the two movable die elements are provided with shaping surfaces configured for shaping the external threaded mouth zone of the preform.

It should be noted that the shape of the punch, of the die cavity and of the movable die elements determine the geometrical shape of the desired preform, i.e. the size thereof. In particular, the difference in diameter between the punch and the die cavity determines the final thickness of the preform whilst the longitudinal dimensions of the punch and of the die cavity determine the length of the preform.

In order to ensure that the plants for compression-moulding of preforms can pass rapidly from the production of a preform of one size to the production of a preform with a different size, there is therefore the need for the elements that determine of the size of the preform (punch and/or die cavity and/or movable die elements) to be replaced very rapidly.

The punch and the cavity are mutually movable towards and away from one another along a moulding direction that is typically vertical. Otherwise, the two movable die elements can move between a position spaced apart from the moulding direction in which the shaping surfaces associated with each die part are mutually distant and a contact position, in which the shaping elements are near one another.

The first half mould further comprises a cylindrical body that slidably houses internally in the moulding direction a hollow pressing sleeve that in turn slidably houses the punch, said pressing sleeve maintaining the movable die elements in contact together in the contact position at least in a final preform forming step and initial preform extracting step. The first half mould comprises at least a chamber obtained in the interior thereof that is supplied with pressurised fluid that acts on at least one wall of the pressing sleeve, so as to push the latter outside the cylindrical chamber in contact with the movable die elements. The chamber with the pressurised fluid provides a pneumatic system acting on this pressing sleeve.

During operation, the first half mould and the second half mould are spaced apart to receive inside the die cavity a dose of plastics to be shaped. Subsequently, when the two movable die elements are in reciprocal contact retained by the pressing sleeve of the upper half mould, the second half mould is brought near the punch by an actuating device and the plastics start to be distributed inside the die cavity. In this initial forming step, it is sufficient that the pneumatic system acting on the pressing sleeve exerts a relatively low initial force to maintain the two movable element in contact. During a final forming step, when the plastics reach the two movable elements, it is necessary for the pneumatic system to exert on the pressing sleeve a force that is significantly greater than the initially exerted force to contrast the action of the plastics that tend to move the two movable elements away from one another.

Each of WO 2007/017418 and WO 2007/144312 discloses the apparatus of the preamble of claim 1.

In order to ensure that the pneumatic system exerts on the pressing sleeve various forces at various forming steps, it is known from WO2007/017418 to provide the pneumatic system acting on the pressing sleeve by supplying the chamber inside the cylindrical body with a low-pressure first fluid in the initial step and by means of a second high-pressure fluid in the final step. Alternatively to the pneumatic system with a single chamber, WO2007/017418 discloses a pneumatic system having two chambers, obtained inside the cylindrical body and isolated from one another that are supplied respectively by a low-pressure fluid and by a high-pressure fluid that start operation in succession. In order to provide such chambers, the cylindrical body houses a cylindrical cup portion that is connected to the cylindrical body and arranged around the pressing sleeve and a further slidable intermediate sleeve that is interposed between said cylindrical cup portion and the external cylindrical body. One problem of the previously disclosed devices resides in the fact the pressurised chamber that provides the pneumatic system acting directly on the pressing sleeve faces and is bounded by a wall of the punch. As a result, dismantling the punch, for example replacing the punch in the event of production of preforms with a different size, can be performed only after interrupting the supply to the first and to the second circuit of pressurised fluid, and only after emptying the circuits. Further, as replacing the punch also implies dismantling and refitting the entire first half mould with complicated alignment operations between the various components with which the first half mould is provided, a size change over requires a long period of machine downtime for the compression-moulding apparatus.

A further problem of the devices disclosed above resides in the fact that the presence of two chambers supplied by respective pressurised fluids requires a mechanically complex structure and with many components for which high-precision production is required.

One object of the invention is to improve the apparatus for forming preforms by compression moulding.

Another object is to provide an apparatus that enables the punch of a first half mould to be replaced rapidly and easily without having to perform successive complex and laborious re-start and adjusting operations so as to minimise machine downtime.

A further object is to make an apparatus that enables pneumatic system acting for maintaining the movable elements pressed strongly against the second half mould in a final forming step, said apparatus being easy to make.

According to the invention, an apparatus is provided for compression-moulding preforms from a dose of plastics according to claim 1.

Owing to the fact that the apparatus comprises a punch arrangement, a die arrangement provided with a cavity, at least two die elements that are mutually movable between a contact position and a detached position and that said punch arrangement is provided with a pressurised chamber that is entirely bounded by a pressing sleeve and by a jacket arrangement of said punch arrangement, a corresponding punch of the latter can be dismantled by the apparatus without emptying a circuit of pressurised fluid that is contained in said chamber and acts on the pressing sleeve. This enables the size change over operation to be accelerated, i.e. rapid replacement of the installed punch with a punch of a different size.

In one embodiment, the punch arrangement of the apparatus comprises a single chamber supplied in an initial forming step of said preforms with a first fluid at a first pressure and in a final forming step with a second fluid at a second pressure.

In a further embodiment, the punch arrangement of the apparatus comprises two chambers containing a first fluid at a first pressure and a second fluid at a second pressure that start to function in succession in an intermediate and final forming step of said preforms and stop functioning in succession in an initial and intermediate extracting step of said preforms.

Owing to this embodiment, the first chamber acts directly on the pressing sleeve and the second chamber acts directly on an intermediate sleeve that in turn acts on a forming sleeve mounted slidably on the punch. Said pressing sleeve and said forming sleeve cooperate, generating respective distinct forces acting on distinct portions of the movable elements to push simultaneously but independently said movable elements towards the die arrangement.

In one embodiment, the apparatus comprises a first fixing device and a second fixing device to lock the punch arrangement in respective seat elements of the compression-moulding apparatus.

According to this embodiment, when a scheduled maintenance operation is necessary for the punch arrangement, it is possible to dismount rapidly the punch arrangement and then replacing the punch arrangement without complicated centring and aligning operations of the mechanical components.

In one embodiment, the apparatus comprises a connecting device for removably connecting the punch to the punch arrangement when the latter is dismantled and extracted from the apparatus.

The invention can be understood and implemented better with reference to the attached drawings that illustrate some embodiments thereof by way of non-limiting example, in which:

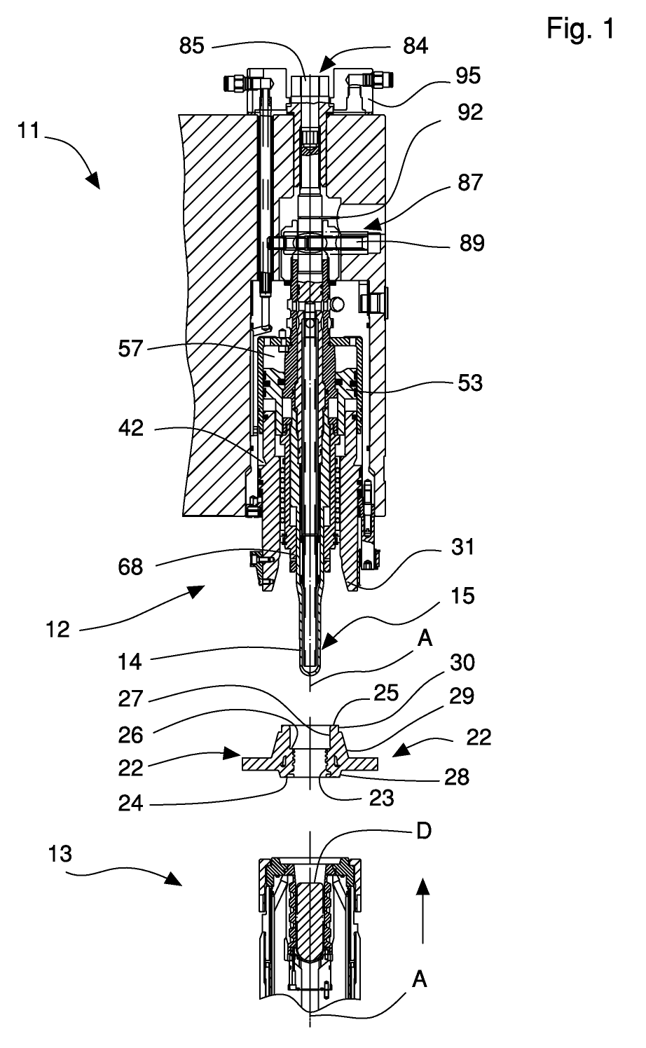

FIG. 1 is a section of an apparatus for compression-moulding a dose of plastics for obtaining the preform in FIG. 8, showing a die arrangement, a punch arrangement and movable die elements in an open operating position;

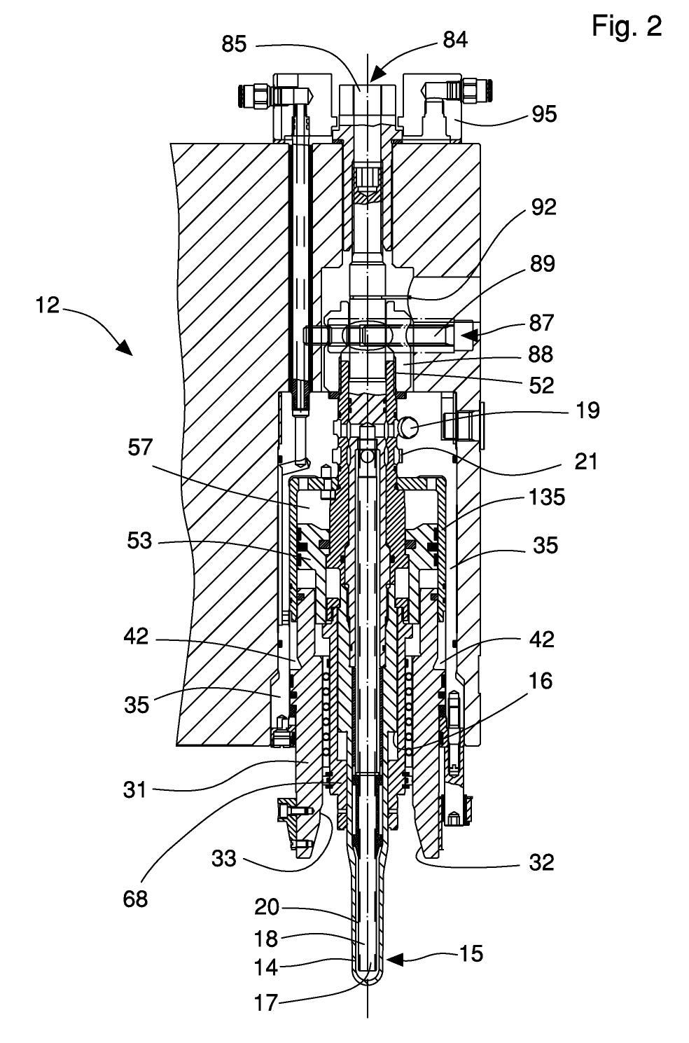

FIG. 2 is an enlarged section of the apparatus in FIG. 1, showing the punch arrangement in an assembled configuration;

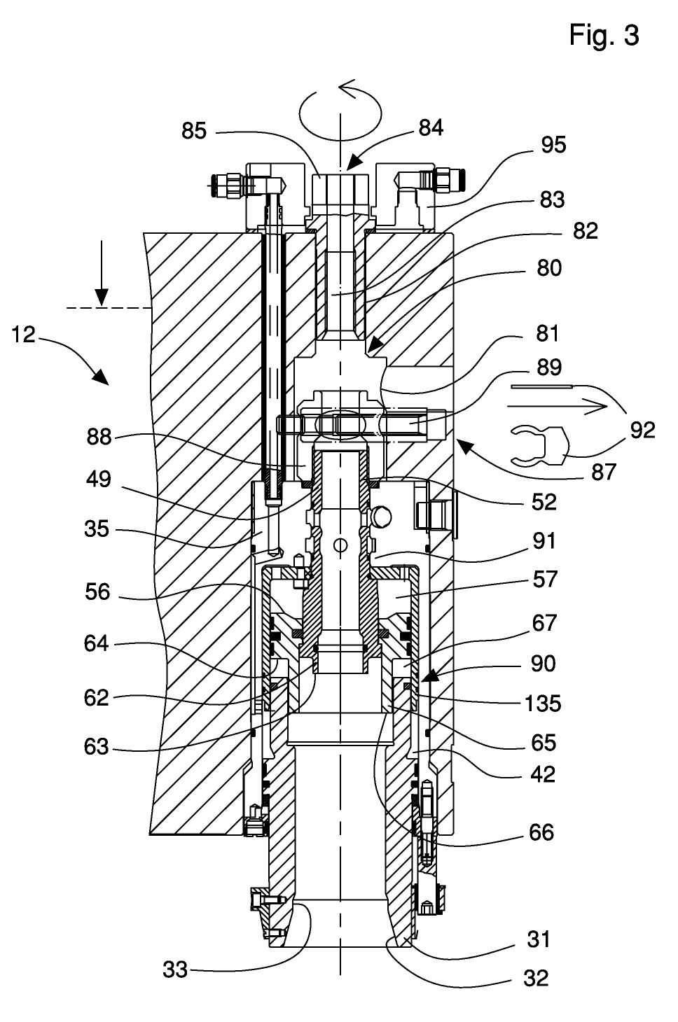

FIG. 3 is an enlarged section of the punch arrangement in FIG. 1 in a first dismantled configuration, in which the punch is extracted from the first half mould;

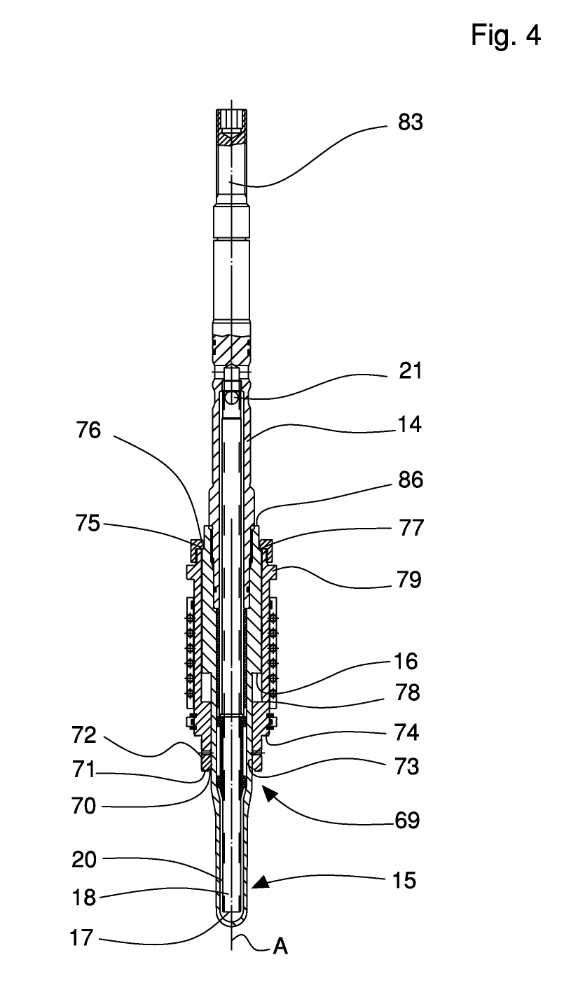

FIG. 4 is a partially sectioned frontal view of the punch extracted from this punch arrangement;

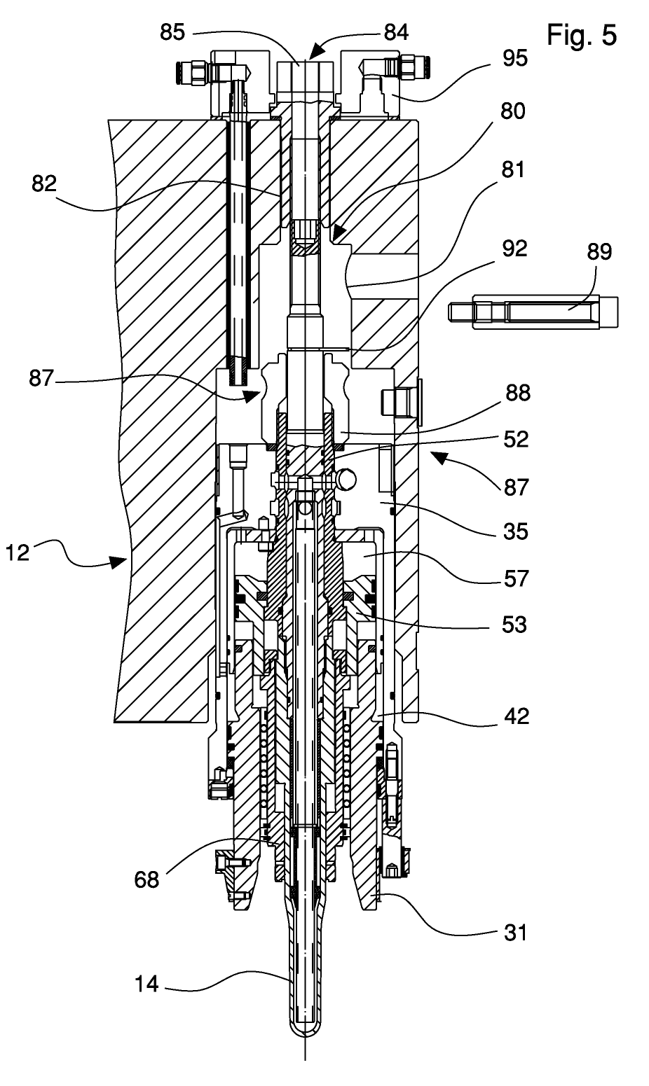

FIG. 5 is a section of the punch arrangement in a second dismantled configuration in which they are partially dismantled and extracted from the respective seat elements of the apparatus;

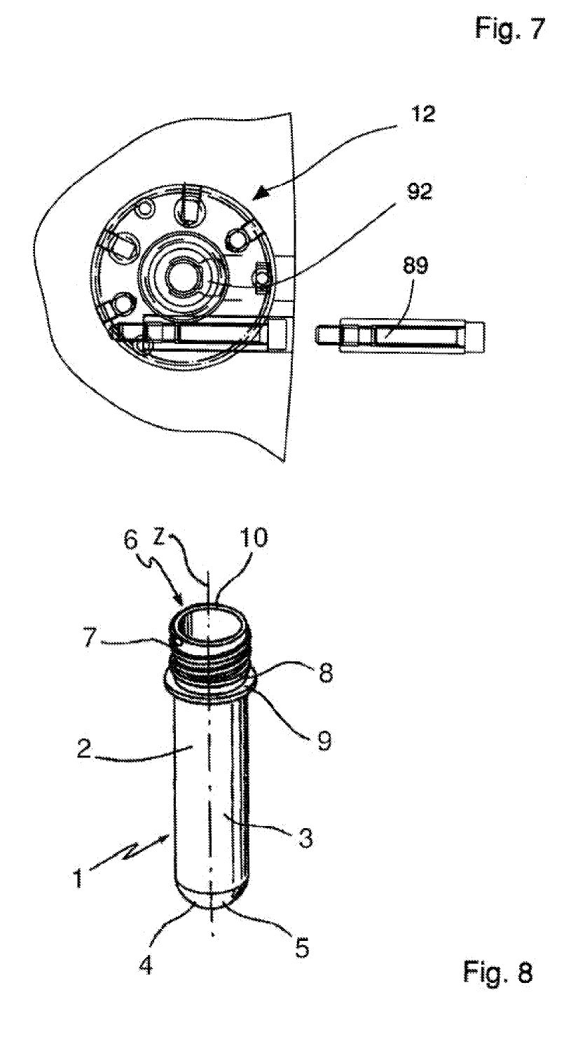

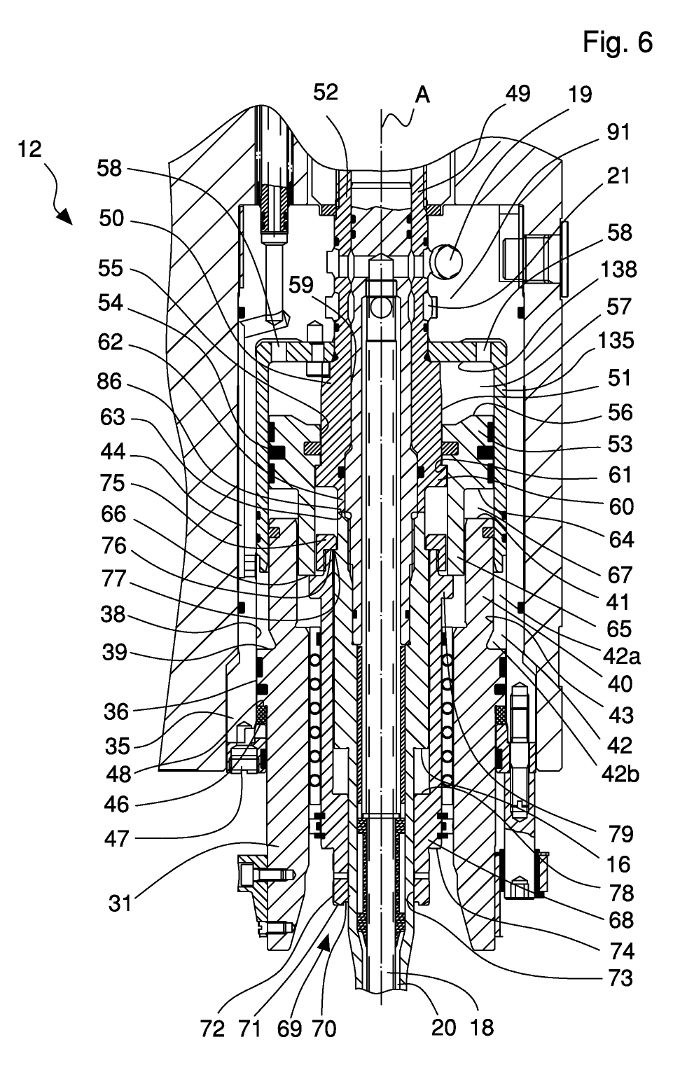

FIG. 6 is an enlarged section of the apparatus in FIG. 2, with some parts removed for the sake of clarity;

FIG. 7 is a section view along the line VII-VII in FIG. 3, in which the side pin is shown in an inserted position and is shown by a dashed line in the retracted position;

FIG. 8 is a schematic perspective view of preform compression-moulded by the apparatus of the invention and used to make a bottle.

FIG. 8 shows a preform 1 that is usable for obtaining a container, particularly a bottle, by a stretch-blow-moulding process. The preform 1 is made of plastics, for example polietilentereftalato (PET), polypropylene (PP), polyvinyl chloride (PVC), polyethylene naphthalate (PEN), high-density polyethylene (HDPE). The preform 1 comprises a hollow body 2 extending along a longitudinal axis Z and bounded by an external surface 3. The hollow body 2 has a first end closed by a transverse wall 4, shaped as a dome, bounded externally by a base surface 5. At a second end of the preform 1, opposite the first end, there is obtained a mouth 6, also called “finish”, that is not subject to noteworthy variations in shape during the stretch-blow-moulding process.

The mouth 6 comprises a threaded portion 7, that is suitable for engaging with a corresponding further threaded portion of a cap, a circular ridge 8 and generally a ring 9 arranged below the threaded portion 7. The mouth 6 is bounded above by an annular edge zone 10, substantially having the shape of a circular crown.

FIG. 1 shows a moulding apparatus 11 included in a moulding carousel to obtain preforms of the type shown in FIG. 8, by compression moulding of a dose D of plastics.

The moulding carousel, rotating around a rotation axis that can, for example, be vertical, may comprise a plurality of moulding apparatuses 11 mounted in a peripheral region of said carousel.

The apparatus 11 comprises a punch arrangement 12 opposite a die arrangement 13, the punch arrangement 12 facing the die arrangement 13 in order to interact together to form the preform 1. In the example shown, the punch arrangement 12 is arranged above the die arrangement 13, but it is possible for the punch arrangement 12 to be arranged below the die arrangement 13 or for the punch arrangement 12 and the die arrangement 13 to be positioned at the same level.

As shown in FIGS. 2 and 6, the punch arrangement 12 comprises a punch 14 extending along a moulding axis A and provided with an external forming surface 15 for internally shaping the preform 1. The punch 14 is provided with a first shoulder 16 positioned above the external forming surface 15.

Inside the punch 14 there is housed a pipe 17, inside which there is defined an inlet conduit 18 that is arranged along the moulding axis A and can be traversed by a cooling fluid. The inlet conduit 18 communicates with a source of cooling fluid, not shown, through an inlet opening 19. Between the pipe 17 and the punch 14 there is defined an outlet conduit 20, in particular shaped as an annular gap that enables the cooling fluid to exit the moulding unit 11 through an outlet opening 21.

As shown in FIG. 1, the apparatus 11 further comprises a pair of movable die elements 22, that are suitable for shaping the mouth 6 of the preform 1. The movable elements 22 can be moved by a driving device, not shown, between a contact position and a detached position. In the contact position, the movable elements 22 are in reciprocal contact and define a complex forming surface 23 that enables the threaded portion 7, the circular ridge 8 and the ring 9 to be shaped. These zones of the preform 1 define undercut parts that can be removed from the moulding apparatus 11 by removing the movable elements 22 from one another, as occurs in the detached position, along a distance that is substantially orthogonal to the moulding axis A.

In an embodiment that is not shown, the moulding apparatus 11 may comprise more than two movable elements 22.

Each movable element 22 is bounded transversely to the moulding axis A by a lower surface 24 and by an upper surface 25. Inside each movable element 22 a step is obtained that is arranged above the complex forming surface 23, the step is bounded by a transverse surface 26 that extends transversely to the moulding axis A and by a guiding surface 27 that is arranged substantially along the moulding axis A. On each movable element 22 it is possible to define a first coupling surface 28, which is substantially frustoconical that laterally bounds the movable element 22 near the lower surface 24. A second coupling surface 29, which is also substantially frustoconical, is arranged outside each movable element 22 at a higher level than the first coupling surface 28. The second coupling surface 29 is joined to the upper surface 25 by a cylindrical portion 30.

As shown in FIGS. 2 and 6, the moulding apparatus 11 comprises a pressing sleeve 31 that interacts with the movable elements 22 to maintain the movable elements 22 in reciprocal contact in the contact position. The pressing sleeve 31 extends along the moulding axis A, around the punch 14. In a lower portion of the pressing sleeve 31 and inside the latter a substantially frustoconical containing and retaining surface 32 is provided that in the contact position interacts with the second coupling surface 29 of the movable elements 22. An internal cylindrical portion 33 obtained inside the pressing sleeve 31 above the retaining surface 32 is suitable for interacting with the cylindrical portion 30 of each movable element 22.

With particular reference to FIG. 6, the punch arrangement 12 comprises a jacket arrangement 91 that includes a tubular external jacket 35 inside which the pressing sleeve 31 is slidably mounted so as to be movable linearly parallel to the moulding axis A.

The external jacket 35 comprises a side wall of substantially cylindrical shape provided with an internal side surface 38, and a bottom wall that is substantially transverse to said side wall and provided with an annular bottom surface 138.

In the illustrated embodiment, the jacket arrangement 91 comprises a cylindrical element 135 that is fixed to the external jacket 35 and makes an internal portion of said internal side surface 38 and of said annular bottom surface 138.

The cylindrical element 135 can, however, also be made integrally with the external jacket 35.

The pressing sleeve 31 has a cylindrical external surface 36 a portion of which located above the retaining surface 32 is suitable for interacting with a portion of said internal side surface 38 to guide the sliding of the pressing sleeve 31 inside the external jacket 35.

A transverse annular wall 39 bounds the pressing sleeve 31 above from the cylindrical external surface 36 to the moulding axis A and from said transverse annular wall 39 a tubular protrusion 40 extends terminating with a respective end transverse wall 41. An end portion of said tubular protrusion 40 is slidable inside the external jacket 35.

A first pressurised fluid, for example compressed air at a first pressure, is contained in an annular lower first chamber 42 obtained above the transverse annular wall 39 and bounded by the latter, by the internal side surface 38 of the external jacket 35, by a cylindrical surface portion 43 of the tubular protrusion 40 facing the external jacket 35 and by a lower annular edge of said cylindrical element 135.

The first lower chamber 42 is thus entirely bounded by the pressing sleeve 31 and by said external jacket 35. The first pressurised fluid enters the lower chamber 42 through a first supply conduit 44 obtained inside the external jacket 35 and supplied by an external source of pressurised fluid that is not illustrated. In particular, the first supply conduit 44 is obtained by a groove of the external jacket 35 that is open towards the exterior.

The first pressurised fluid acts on the transverse annular wall 39 of the pressing sleeve 31, pushing the pressing sleeve 31 towards the outside of the external jacket 35, i.e. to the movable die elements 22. In other words, the first pressurised fluid exerts on the pressing sleeve 31 a pressure force that is parallel to the moulding axis A, directed towards the die arrangement 13, thus providing a first pneumatic system acting on said pressing sleeve.

The lower chamber 42, along the moulding axis A, is shaped and has a first portion 42a, the annular cross section thereof being substantially constant and a second portion 42b, made owing to a corresponding recess obtained in the pressing sleeve 31, the annular cross section of which on the other hand increases towards the die arrangement 13 and ends with the transverse wall 39, with the greatest cross section. In this manner it is possible to obtain a lower chamber 42 that has substantially small overall dimensions whilst obtaining an extended surface of interaction between pressurised fluid and pressing sleeve 31.

On a lower portion of the external jacket 35 a stopping ring nut 47 is mounted that is arranged for preventing the exit of the pressing sleeve 31 pushed by the pressurised fluid of the lower chamber 42 towards the die arrangement.

The stopping ring nut 47 is arranged in particular for abutting on an external shoulder 48 obtained on the external surface 36 of the pressing sleeve 31.

The stopping ring nut 47 constitutes the limit stop of the pressing sleeve 31 in an operating position of maximum extent of the latter. In particular, between the external shoulder 48 of the pressing sleeve 31 and the stopping ring nut 47, there is interposed a replaceable element 46, substantially a cylindrical annular spacer, that enables the limit stop position of the pressing sleeve 31 to be modified with respect to the external jacket 35.

The jacket arrangement 91 further comprises a tubular inner jacket 49, fixed to the external jacket 35 and provided with a through housing 59 which is arranged for receiving the punch 12 and for supporting the punch together with the external jacket 35.

The inner jacket 49 has a first portion 50, contained inside the external jacket 35 and having a substantially cylindrical external surface 51, and a second portion 52, opposite the first portion 50 that extends outside the external jacket 35.

The punch arrangement 12 comprises an intermediate sleeve 53 slidably mounted and interposed between the external jacket 35 and the first portion 50 of the inner jacket 49. In order to guide the sliding of the intermediate sleeve 53 between the external jacket 35 and the inner jacket 49, a cylindrical external surface 54 of the intermediate sleeve interacts with a portion of the internal side surface 38 of the external jacket 35; a cylindrical internal surface 55 of the intermediate sleeve 53 interacts with a portion of the external cylindrical surface 51 of the inner jacket 49. The intermediate sleeve 53 is bounded above by a substantially transverse wall 56.

A second pressurised fluid, for example compressed air at a second pressure, is contained in an annular upper second chamber 57, which is made above the transverse annular wall 56 and is bounded by the latter, by the internal side surface 38, by the bottom surface 138 of the external jacket 35 and by the external surface 51 of the first portion 50 of the inner jacket 49. The second pressurised fluid of the upper chamber 57 is at a second pressure, the second pressure being greater than the first pressure of the pressurised fluid of the lower chamber 42.

The second fluid at said second pressure enters the upper chamber 57 through a plurality of respective supply conduits 58 (or also, in an alternative embodiment that is not shown, by a single second supply conduit 58) obtained inside the external jacket 35 and supplied by a second external source of pressurised fluid that is not illustrated. The pressurised fluid acts on the transverse annular wall 56 of the intermediate sleeve 53, pushing the intermediate sleeve 53 outside the external jacket 35, i.e. to the movable die elements 22. In other words, the pressurised fluid exerts on the intermediate sleeve 53 a pressure force that is parallel to the moulding axis A and is directed to the die arrangement 13.

The inner jacket 49 comprises a first annular ridge 60 an upper wall of which constitutes a shoulder that is suitable for abutting on a corresponding shoulder 61 of the intermediate sleeve when the latter is pushed to the die arrangement 13 by the pressurised fluid of the upper chamber 57 and is in an operating position of maximum extent. The first annular ridge 60 of the inner jacket 49 thus constitutes the limit stop of the intermediate sleeve 53 in an operating position of maximum extent.

The inner jacket 49 further comprises a tubular protrusion 62, connected to the ridge 60 on a side opposite the second chamber 57, extending towards the die arrangement and provided with a respective end transverse wall 63.

The intermediate sleeve 53 comprises a transverse lower annular wall 64 that extends from the cylindrical external surface 54 on an opposite side to the upper transverse wall 56. Adjacent to said wall 64, a tubular protrusion 65 extends that terminates with a transverse end wall 66. Between said intermediate sleeve 53 and said external jacket 35, in particular between said tubular protrusion 65 and the internal side surface 38 of the external jacket 35 there is defined an annular seat 67 that is suitable for slidably receiving the tubular protrusion 40 of the pressing sleeve 31. In particular, the transverse end wall 41 of the tubular protrusion 40 of the pressing sleeve 31 is suitable for approaching without ever abutting on, the transverse lower annular wall 64 of the intermediate sleeve 53, when the pressing sleeve 31 is in a retracted operating position. In this operating position of the pressing sleeve 31, as will be explained better below, the pressurised fluid in the second chamber 57 acts directly on the intermediate sleeve 53 whilst the pressing sleeve 31 is pushed towards the die arrangement 13 by the thrust generated directly thereupon by the pressurised chamber 42.

As illustrated in FIG. 4 and in FIG. 6, between the pressing sleeve 31 and the punch 14 a forming sleeve 68 is interposed that has a tubular shape that is slidably mounted on said punch 14 and is substantially coaxial thereto. A portion of the punch 14 bounded by the external forming surface 15 exits from the forming sleeve 68 and faces the die arrangement 13.

The forming sleeve 68 is bounded below by an end 69 in which an annular forming surface 70 is obtained, arranged towards the punch 15 and suitable for shaping the annular edge 10 of the preform 1, and a first transverse interaction surface 71 is obtained, arranged externally and facing the transverse surface 26 of each movable element 22.

Parallel to the moulding axis A and near the lower end 69 thereof, the forming sleeve 68 is bounded externally by an external guiding surface 72 that can engage with the guiding surface 27 of each movable element 22. Inside, the forming sleeve 68 is on the other hand bounded by an internal guiding surface 73 that can slide along the punch 14.

Above the external guiding surface 72, the forming sleeve 68 has a zone of greater diameter and is bounded below, transversely to the moulding axis A, by a second interaction surface 74 that can interact with the upper surface 25 of each movable part 20.

A ring nut element 75 is fixed to an upper end of the forming sleeve 68, for example by a threaded connection, and said ring nut element 75 has an internal edge 76 that is suitable for engaging with a second shoulder 77 obtained on the punch 14.

The second shoulder 77 constitutes the limit stop of the forming sleeve 68 in a respective operating position of maximum extent and in fact prevents the forming sleeve 68 from detaching from the punch 14 and limits the movement thereof during the forming process.

Inside the forming sleeve 68 an internal shoulder 78 is obtained that can abut on the first shoulder 16 obtained on the punch 14.

The forming sleeve 68 further comprises an annular ridge 79 provided at the upper surface of said forming sleeve 68 and arranged for abutting on the transverse end wall 66 of the intermediate sleeve 53 when the latter is in the respective operating position of maximum extent. In this operating position, the second pressurised fluid in the second chamber 57 acts directly on the intermediate sleeve 53 and indirectly on the forming sleeve 68, which is pushed towards the die arrangement 13 by the transverse end wall 66 of the intermediate sleeve 53. The second pressurised fluid thus provides a second pneumatic system acting on said intermediate sleeve 53.

With reference to FIGS. 3, 4 and 5, the forming sleeve 68 and the punch 14 are connected and are dismantleable by the punch arrangement 12, without the need to empty the first pressurised fluid in the first lower chamber 42 and the second pressurised fluid in the second upper chamber 57. In fact, as shown in FIG. 3 in which the punch 14 is dismantled, both the first and the second chamber are entirely bounded by the walls of the inner jacket 49 and/or of the external jacket 35, and by walls that are part of the intermediate sleeve or of the pressing sleeve 31 and accordingly both the first and the second chamber are completely isolated from the punch 14, which can be possibly replaced by another one of another type.

It should further be noted that the apparatus 11 comprises a manifold 95 for distributing both the cooling liquid and the first pressurised fluid and the second pressurised fluid. In particular, the manifold comprises a hollow ring-shaped element located above the punch arrangement 12 to which the first pressurised fluid, the second pressurised fluid and the cooling liquid flow in distinct angular positions, which is able to isolating the circulating liquid inside the punch 14 from the rest of the liquid circulating in the distribution circuit.

When dismantling the punch 14, it is not therefore necessary to empty entirely the circuit of the cooling fluid and only the fluid inside the punch 14 will be lost.

The apparatus 11 further comprises seat elements 80 (FIGS. 3 and 5) arranged for receiving the punch arrangement 12. In particular, the seat elements 80 comprises a first seat 81 arranged for housing the jacket arrangement 91, i.e. the external jacket 35, the possible cylindrical element 135 fixed to the external jacket 35 and the inner jacket 49, and a second seat 82 arranged for housing an end portion 83 of the punch 14, opposite the external forming surface 15.

Inside the second seat 82, the apparatus 11 comprises a first fixing device 84 for removably locking said punch 14 in said second seat 82. The first fixing device 84 comprises, for example, a female screw 85 that is rotatably inserted into the second seat 82 and has an internally threaded end portion that is suitable for receiving the threaded end portion 83 of the punch 14.

It should be noted that the punch 14 has an abutting portion 86, that is an abutting edge, which abuts on the transverse end wall 63 of the tubular protrusion 62 of the inner jacket 49, when the punch 14 is inserted inside the inner jacket 49. The abutting edge 86 thus enable the jacket arrangement 91 to be locked inside the first seat 81 with a force parallel to the moulding axis A and directed to the first fixing device 84, when the punch 14 is locked by the first fixing device 84 in the second seat 82.

The apparatus 11 comprises a second fixing device 87 that enables the jacket arrangement 91 to be locked removably in said first seat 81 when the punch 14 is dismantled.

The second fixing device 87 comprises a bush 88 housed inside the first seat 81 and fixed, for example by a threaded connection, to the free end 52 of the inner jacket 49. The second fixing device 87 further comprises a removable transverse pivot 89 that fixes the bush 88 to a wall of the first seat 81.

The punch arrangement 12 of the invention comprises substantially an external cartridge 90, to which the jacket arrangement 91—i.e. the external jacket 35 and the inner jacket 49—the pressing sleeve 31 and the intermediate sleeve 53 belong, and inside which cartridge the first chamber 42 and the second chamber 57 are entirely bounded. The external cartridge 90 remains fixed in the first seat 81, by virtue of the second fixing device 87, with the pressurised chambers, even when the punch 14 is extracted.

Between the bush 88 and the first fixing device 84, the apparatus 11 comprises a removable connecting device 92 comprising for example an extractable safety spring that secures the punch 14 to the external jacket 35 and to the inner jacket 49, regardless of the first fixing device 84 and of the second fixing device 87. In this manner the punch arrangement 12 can be extracted completely from the seat elements 80, for maintenance operations.

During operation, the moulding apparatus 11 is located initially in an open position shown in FIG. 1, in which the die arrangement 13 is spaced apart from the punch arrangement 12 to receive a dose D of plastics in melted/pasty state in the die cavity from a transferring arrangement that is not shown.

The movable elements 22 are maintained in the contact position by the pressing sleeve 31 in the respective operating position of maximum extent, inasmuch as the pressing sleeve 31 is pushed initially to the die arrangement 13 by the first fluid at a first pressure of the first lower chamber 42. Also the intermediate sleeve 53 is in the respective operating position of maximum extent, being pushed by the second fluid at a second pressure of the second chamber 57. Similarly, as already previously illustrated, also the forming sleeve 68 is in the operating position of maximum extent inasmuch as it is pushed by the intermediate sleeve 53.

Subsequently, in an initial forming step, an actuator moves the die arrangement 13 to the punch arrangement 12. The upper end of the dose D comes into contact with the lower end of the punch 14.

Whilst the actuator continues to move the die arrangement 13 towards the punch arrangement 12, the punch 14 starts to squeeze the dose D, deforming the dose and redistributing the dose inside the die cavity. In particular, the plastics, pressed by the punch 14 expands and entirely occupies the part of the die cavity arranged below the punch 14 and starts to take the shape of the internal forming surface of the die cavity that will constitute the external surface 3 of the preform 1.

Subsequently, the die arrangement 13 comes into contact with the lower surface 24 of the movable elements 22. In particular, the frustoconical surface 28 of the movable elements 22 is engaged in a shapingly coupled manner with the upper portion of the die arrangement 13, which has a complementary shape.

The plastics contained inside the die cavity, pressed by the punch 14 start to rise to the movable elements 22, whilst maintaining themselves below the lower surface 24 of the latter. In this forming step, even if the plastics flow to a higher level already in this step, they could not penetrate the gap between the upper surface of the die cavity and the movable elements 22 because the latter are maintained pressed against the die arrangement 13 by the pressing sleeve 31, on which the fluid at a first pressure of the first chamber 42 acts.

Subsequently, the actuator continues to move the die arrangement 13 upwards and consequently, the die arrangement 13 being in contact with the movable elements 22, the actuator also moves the movable elements 22 and the pressing sleeve 31, which move integrally with the die arrangement 13.

In this step, the forming sleeve 68 is still stationary, kept in the operating position of maximum extent inasmuch as pushed by the intermediate sleeve 53, whilst the guiding surface 27 of the movable elements 22 flows along the external guiding surface 72 of the forming sleeve 68 and the external surface 36 of the pressing sleeve 31 slides on the internal side surface 38 of the external jacket 35. The tubular protrusion 40 of the pressing sleeve 31 slides inside the seat 67 defined between the tubular protrusion 65 of the intermediate sleeve 53 and the external jacket 35. The first fluid at a first pressure contained in the first lower chamber 42 contrasts the pressing sleeve 31 strongly, which maintains the movable elements 22 pressed towards the die arrangement 13.

In an intermediate forming step, the transverse surfaces 26 of the movable elements 22, pushed by the actuator, are positioned near the first interaction surface 71 of the forming sleeve 68, such that they position themselves ad a distance from the interaction surface 71 that is so small as to prevent the plastics from flowing between the transverse surfaces 26, whilst enabling the air inside the die cavity to exit. Simultaneously, the upper surfaces 25 of the movable elements 22 are positioned in contact with the second interaction surface 74 of the forming sleeve 68 and the upper wall of the annular ridge 79 of the latter continues to abut on the transverse end wall 66 of the intermediate sleeve 53. The first transverse end wall 41 of the tubular protrusion 40 of the pressing sleeve 31 slides retracting inside the seat defined between the tubular protrusion 65 of the intermediate sleeve 53 and the external jacket 35.

Between the punch arrangement 12 and the die arrangement 13, there is thus defined a first closed forming chamber, not yet having a shape corresponding to the definitive shape of the preform 1, inasmuch as the punch 14 and the die cavity have not yet reached the corresponding final configuration. The annular forming surface 70 of the forming sleeve 68 closes the first forming chamber whilst the plastics start to fill the first forming chamber completely.

Subsequently, the actuator continues to move the die arrangement 13 upwards and consequently, the die arrangement being in contact with the movable elements 22, the actuator moves integrally upwards the movable elements 22, the pressing sleeve 31 (the retaining surface 32 of the pressing sleeve is in contact with the second coupling surface 29 of the movable elements 22), the forming sleeve 68 (the upper surfaces 25 of the movable elements 22 are in contact with the second interaction surface 74 of the forming sleeve 68) and the intermediate sleeve 53, the latter being in contact with the forming sleeve 68 and being moved by the latter.

In this final forming step, the volume of the forming chamber is reduced progressively until the punch arrangement 12 and the die arrangement 13 reach the final operating configuration in which a second forming chamber is defined having a geometry corresponding substantially to that of the final preform 1. The second fluid at a second pressure of the second upper chamber 57 acts as a gas spring and exerts a contrasting action on the intermediate sleeve 53, which is pushed strongly towards the die arrangement. In this manner the forming sleeve 68, pushed by the intermediate sleeve 53, pushes the movable elements 22 to the die arrangement 13 pressing the movable elements 22 towards the latter. In particular, the annular forming surface 70 of the forming sleeve 68 effectively forms the edge zone 10 of the preform, contrasting the rise of the plastics, whilst the second interaction surface 74 of the forming sleeve 68 strongly pushes the movable elements 22 towards the die arrangement 13.

Simultaneously, the pressing sleeve 31, pushed by the fluid of the first chamber 42 with a pressure force that is due to the first fluid at a first pressure, continues to maintain the movable elements 22 in contact, pressing the movable element 22 strongly towards the die arrangement 13, contrasting the action of the plastics in the forming chamber at the movable elements 22.

The first transverse end wall 41 of the tubular protrusion 40 of the pressing sleeve 31, in the retracted operating position, comes to being near to contact with the lower transverse wall 64 of the intermediate sleeve 53, but without abutting the lower transverse wall 64, whilst the first fluid at a first pressure of the first lower chamber 42 continues to push the pressing sleeve towards the die arrangement 13. In the final forming step, the second chamber 57 thus acts on the forming sleeve 68, inasmuch as the intermediate sleeve 53 abuts on said forming sleeve 68 pushing the forming sleeve 68 towards the movable die elements 22, whilst the first chamber 42 continues to act on the pressing sleeve 31. It should thus be noted that the first chamber 42 and the second chamber 57, although starting to operate in succession, the first chamber 42 by starting to operate before the second chamber 57, cooperate in the intermediate and final forming step, generating respective distinct pressure forces directed to the die arrangement 13 to push simultaneously but independently the movable elements 22 to the die arrangement 13.

In particular, the first chamber 42 and the second chamber 57 act on distinct portions of said movable elements 22, inasmuch as the first chamber 42 acts on the frustoconical coupling surface 29 of the movable elements 22 whilst the second chamber 57 acts on the upper surface 25 thereof.

When the preform 1 has been cooled and stabilised to a temperature at which it can be handled without risks of damage, the moulding apparatus 11 is opened to enable the preform 1 that has just been formed to be removed. It should be noted that as the preform 1 cools it shrinks, remaining firmly clamped around the punch 14.

In an initial extracting step, the actuator remove the die arrangement 13 from the punch arrangement 12, by moving the die cavity downwards.

As a result the second chamber 57, by acting on the intermediate sleeve 53 that abuts on the forming sleeve 68, slides the forming sleeve 68 downwards. In turn, the second interaction surface 74 of said forming sleeve 68 abuts on the upper surface 25 of the movable die elements 22 and pushes the latter downwards or towards the die arrangement 13. Simultaneously, the first chamber 42 pushes the pressing sleeve 31 downwards and thus also the pressing sleeve 31, as the retaining surface 32 of said pressing sleeve 31 abuts on the frustoconical coupling surface 29 of said movable elements 22, pushes the movable elements 22 downwards. It should therefore be noted that the first chamber 42 and the second chamber 57 cooperate in the initial extracting step, generating respective distinct forces directed towards the die arrangement 13 to push simultaneously the movable elements 22 downwards.

In this initial extracting step, the preform 1 is associated with the movable elements 22 because the threaded portion 5, the circular ridge 6 and the ring 7 are clamped by the complex forming surface 23. Moving towards the die arrangement 13, the movable elements 22 thus detach the preform 1 from the punch 14, overcoming the friction between the preform 1 and the punch 14.

It is important to remark that the preform 1 is removed from the punch 14, guided by the forming sleeve 68 as far as the operating position of maximum extent of the forming sleeve 68 is achieved, inasmuch as the forming sleeve 68 slides downwards, the annular forming surface 70 of the forming sleeve 68 pushing on the edge zone 10 of the preform 1 and preventing possible deformations thereof.

The pressing sleeve 31, which cooperates as disclosed above with the forming sleeve 68, contributes to removing the preform 1 from the punch 14 and in particular stabilises the threaded portion 5 of the preform 1, preventing possible radial deformation thereof.

In an intermediate extracting step, the forming sleeve 68 stops in an advanced operating position, inasmuch as the internal edge 76 of the ring nut element 75 engages with the second shoulder 77 obtained on the punch 14. In the meantime, the tubular protrusion 40 of the pressing sleeve 31, which continues to be pushed by the first fluid of the first chamber 42, slides inside the seat 67, defined between the tubular protrusion 65 of the intermediate sleeve 53 and the external jacket 35, towards the die arrangement 13.

It should therefore be noted that first chamber 42 and the second chamber 57, although ceasing to operate in succession, the second chamber ceasing to operate before the first chamber 42, cooperate both in the initial and in the intermediate extracting step, generating respective distinct forces directed to the die arrangement 13 to push simultaneously, but independently, the movable elements 22 towards the die arrangement 13.

In a final extracting step, the first pressurised fluid contained in the first lower chamber 42 further pushes the pressing sleeve 31 towards the die arrangement 13 and moves away from the forming sleeve 68, maintained stationary by the second shoulder 77 of the punch 14. The movable elements 22, maintained in reciprocal contact by the pressing sleeve 31, moves downwards together the latter and continue to remove the preform 1 from the punch 14. It should be known that in this step the preform 1, which is already detached from the external forming surface 15, can be removed from the punch 14 with a relatively low extracting force, which is performable only by the first pressurised fluid contained in the first lower chamber 42.

During an operation of maintenance of the compression-moulding apparatus, in which, for example, cleaning and/or testing of the punch arrangement 12 installed in the apparatus 11 is necessary, it is above all necessary to proceed by emptying the supply conduit 44 of the compressed air to the first chamber 42 and the supply conduit 58 of the compressed air to the second chamber 57, that is the circuit of the compressed air of the apparatus 11. Further, the distribution of the circulating cooling liquid in the apparatus must be isolated from the cooling liquid circulating inside the punch arrangement 14.

It is possible to dismantle the punch arrangement 12 completely from the apparatus 11, extracting the punch arrangement 12 from the seat elements 80, by acting on the female screw 85 on which the punch 14 is screwed and by extracting laterally the transverse pivot 89 that fixes the bush 88 on the seat elements 80. The removable connecting device 92 will anyway maintain the punch 14 connected to the corresponding cartridge 90, ensuring safe dismantling of the punch arrangement from the apparatus 11.

It should be known that, after the maintenance operation, the punch arrangement 12 is mounted without the need to perform long adjusting and aligning operations of the components, inasmuch as the seat elements constitute per se the centring device of the punch arrangement during the mounting step.

During a size change over operation, or when there is the need to make preforms 1 of a different weight and/or of a different shape, by isolating the distribution of the circulating cooling liquid in the apparatus from the circulating cooling liquid inside the punch 14 it is possible to replace in a short time the punch 14 with a punch of different size by acting on the female screw 85 on which the punch 14 is screwed. When the punch has been dismantled, both the first chamber 42 and the second chamber 57 inside the cartridge 90 continue to remain pressurised, and therefore, after screwing the new punch 14 having different size inside the inner jacket 49 and after re-establishing the cooling liquid inside the latter, the apparatus 11 is already ready for being operational. The punch 14 does not in fact need any type of alignment inside the inner jacket 49, sliding inside the latter during mounting and being locked thereupon by the abutting edge 86.

The apparatus 11 disclosed above thus has the advantage of ensuring optimum pressure force acting on the movable elements 22 by means of the pressing sleeve 31 and by means of the forming sleeve 68—in particular a reduced pressure force in an intermediate forming step, a much greater pressure step in the final forming step—whilst enabling great flexibility during operation. In particular, making the chambers 42, 57 entirely defined by walls of the pressing sleeve 31 and of the jacket arrangement 91 enables the aforesaid chambers 42, 57 to be isolated from the punch 14 in order to permit rapid dismantling and mounting of the punch 14 for a size change over.

Further, the structure of the apparatus 11 is particularly simplified as the first pneumatic system made by the first chamber 42 and the second pneumatic system made by the second chamber 57 generate pressure forces that are parallel to one another and of a different value, that push distinct portions of said movable elements 22 towards the die arrangement 13. This is also particularly advantageous, inasmuch as it enables a respective optimum pressure force to be applied to each portion of said movable elements 22, said force being able to form and subsequently extract the mouth zone 6 of the preform 1 from the punch 14 without deformation, in an intermediate and final forming step and in an initial and intermediate extracting steps.

In one embodiment that is not illustrated, the first chamber 42 and the second chamber 57 cooperate exclusively in the final forming step and initial extracting step, when there is a need for maximum pressure force to push simultaneously but independently the movable elements 22 to the die arrangement 13.

In an alternative embodiment that is not shown in the figures, the apparatus 11 has a single chamber, for example the upper chamber 57 supplied with a pressurised fluid that in an intermediate forming step has less pressure and in a final forming step has greater value. The pressing sleeve 31 and the intermediate sleeve 68 collaborate integrally together to make a single slidable pressing sleeve 31 acting on the movable elements 22. It should be known that also in this alternative embodiment, the punch 14 can be extracted from the punch arrangement 12 without the need to empty the circuit of the pressurised fluid.

1-27. (canceled)

28. Apparatus for compression-moulding preforms from a dose of plastics, comprising a punch arrangement and a die arrangement provided with a cavity and at least two die elements which are mutually movable between a contact position and a detached position; said punch arrangement comprising a punch that is suitable for being inserted into said cavity, a pressing sleeve that is slidably mounted around said punch to maintain said at least two die elements in said contact position, a jacket arrangement arranged for receiving said punch and said pressing sleeve, at least a first chamber containing a first fluid at a first pressure and acting on said pressing sleeve, wherein said first chamber is entirely bounded by said pressing sleeve and by said jacket arrangement so as to enable said punch to be dismantled from said punch arrangement, maintaining said first chamber pressurised.

29. Apparatus according to claim 28, comprising seat elements arranged for removably housing said punch arrangement.

30. Apparatus according to claim 29, wherein said jacket arrangement comprises an external jacket, said first chamber being entirely bounded by said pressing sleeve and said external jacket.

31. Apparatus according to claim 30, wherein said jacket arrangement further comprises an inner jacket fixed to said external jacket and arranged for housing said punch, said jacket arrangement supporting said punch.

32. Apparatus according to claim 31, wherein said punch arrangement comprises an intermediate sleeve, which is slidably interposed between said external jacket and said inner jacket so as to define a second chamber, said second chamber containing a second fluid at a second pressure, said second pressure of said second fluid being greater than the first pressure of said first fluid.

33. Apparatus according to claim 32, wherein said inner jacket comprises a shoulder suitable for abutting on a corresponding shoulder of said intermediate sleeve in a respective maximum extent position, said intermediate sleeve being pushed to said respective maximum extent position by said second fluid.

34. Apparatus according to claim 32, wherein between said intermediate sleeve and said external jacket there is defined an annular seat suitable for housing a respective tubular protrusion of said pressing sleeve.

35. Apparatus according to claim 34, wherein said intermediate sleeve comprises a respective tubular protrusion extending towards said die arrangement from an opposite side with respect to said second chamber, said annular seat being defined by said tubular protrusion of said intermediate sleeve and by said external jacket.

36. Apparatus according to claim 28, wherein said punch arrangement comprises a forming sleeve, mounted slidably on said punch and arranged for forming an annular edge zone of said preform.

37. Apparatus according to claim 36, wherein said forming sleeve is interposed between said pressing sleeve and said punch.

38. Apparatus according to claim 36, wherein said forming sleeve is connected to said punch, said punch and said forming sleeve being dismantleable from said punch arrangement.

39. Apparatus according to claim 31, wherein said seat elements comprise a first seat and a second seat.

40. Apparatus according to claim 39, comprising a first fixing device for removably locking said punch in said second seat.

41. Apparatus according to claim 40, wherein said first fixing device comprises a female screw rotatably inserted into said second seat, said female screw comprising an internally threaded end portion for engaging with a threaded end portion of said punch.

42. Apparatus according to claim 40, wherein said punch comprises an abutting portion arranged for abutting on a transverse wall of said inner jacket so as to maintain said inner jacket and said external jacket in said first seat when said first fixing device locks said punch in said second seat.

43. Apparatus according to claim 39, comprising a second fixing device acting on said jacket arrangement so as to maintain the latter in said first seat, in particular when said punch is extracted.

44. Apparatus according to claim 43, wherein said second fixing device comprises a bush connected to a free end of said inner jacket and connected to a wall of said first seat by a removable transverse pin.

45. Apparatus according to claim 36, wherein said punch arrangement comprises an intermediate sleeve, which is slidably interposed between said external jacket and said inner jacket so as to define a second chamber, said second chamber containing a second fluid at a second pressure, said second pressure of said second fluid being greater than the first pressure of said first fluid and wherein said forming sleeve, said intermediate sleeve and said pressing sleeve are movable with respect to said punch from an operating position of maximum extent to a retracted operating position, owing to the force exerted by said die arrangement.

46. Apparatus according to claim 34, wherein said tubular protrusion of said pressing sleeve is in a retracted operating position in said annular seat in an intermediate and/or final forming step of said preforms and in an initial and/or intermediate extracting step of said preforms.

47. Apparatus according to claim 36, wherein said intermediate sleeve comprises a respective tubular protrusion extending towards said die arrangement from an opposite side with respect to said second chamber, said annular seat being defined by said tubular protrusion of said intermediate sleeve and by said external jacket and wherein said forming sleeve comprises an annular ridge arranged substantially on the opposite side to said die arrangement to abut on said tubular protrusion of said intermediate sleeve, said second pressurised fluid in said second chamber acting on said forming sleeve via said intermediate sleeve in an intermediate and/or final forming step of said preforms and in an initial and/or intermediate extracting step of said preforms.

48. Apparatus according to claim 47, wherein said second chamber acting on said forming sleeve by said intermediate sleeve cooperates with said first chamber acting on said pressing sleeve to maintain said at least two die elements in said contact position in an intermediate and/or final forming step of said preforms and in an initial and/or intermediate extracting step of said preforms.

49. Apparatus according to claim 48, wherein said second chamber and said first chamber generate respective forces directed towards the die arrangement acting on distinct portions of said movable elements.

50. Apparatus according to claim 47, wherein said second chamber acting on said forming sleeve starts to operate after said first chamber acting on said pressing sleeve, in said forming step.

51. Apparatus according to claim 47, wherein said second chamber acting on said forming sleeve finishes to operate before said first chamber acting on said pressing sleeve, in said extracting step.

52. Apparatus according to claim 28, wherein said first chamber is shaped and has a portion having a cross-section which increases towards said die arrangement.

53. Apparatus according to claim 28, comprising a removable connecting device for fixing said punch to said jacket arrangement, in particular when said punch arrangement is extracted from said apparatus.

54. Apparatus according to claim 28, wherein a plurality of said punch arrangement, of respective said die arrangement and of respective die elements are included in a rotatable moulding carousel.
